(19) United States
(12) Patent Application Publication
(10) Pub. No.: US 2011/0068094 A1
(43) Pub. Date: Mar. 24, 2011

(54) High energy efficient electric cooking system

(76) Inventor: Hongjun Pan, Denton, TX (US)

(21) Appl. No.: 12/586,296

(22) Filed: Sep. 21, 2009

(51) Int. Cl. H05B 3/68

(52) U.S. Cl. 219/452.11

(57) ABSTRACT

A new electric cooking system is described. This cooking system can be installed on the conventional residential electric ranges. The cooking system contains an electric burner, a cooking pot, a ceramic base plate and a thermal insulation sleeve. The electric burner has a vertical heating structure and two terminal mounting legs, the cooking pot has an inward open slot to host the vertical heating structure of the electric burner; the ceramic base plate is installed on the surface opening of the electric range where the dip pan and electric burner is located. The thermal insulation sleeve is made of the non-flammable fibers or ceramic materials and placed around the side of the cooking pot to prevent the heat lose. Almost 100% of the heat generated by the burner is absorbed by the cooking content and the energy efficiency is about 3 times of the conventional cooking system.

### BACKGROUND OF THE INVENTION

1. Field of the Invention

The invention is related to the electric range top cooking system which includes the electric burner, the cooking pot, the ceramic base plate and the thermal insulation unit.

2. Description of the Prior Art

Almost every family in the world has to cook food. In the modern society, the energy used for cooking is far more than used in transportation. However, the energy efficiency of the cooking is much lower than the transportation; most of the heat generated for cooking is wasted. Ironically, nowadays, due to increase of oil price, global warming effect and gradual depletion of natural resources, governments and scientists around the world are making great effort in design of more fuel efficient vehicles and airplanes, but pay much less attention on improvement of the energy efficiency of cooking. Actually, a little improvement of energy efficiency in the cooking will have far more impact on energy consumption than that by the improvement of transportation. To cook food, the food must be heated and the temperature of the food must reach certain level and should be maintained for certain period of time. At present, the typical electric range top cooking system is shown in the FIG. 1, FIG. 2 and FIG. 3. FIG. 1 is the typical flat coil type electric burner 1, which has the spiral tubular heating element 2 and the two terminal mounting legs 3 which are connected to the electric terminal; FIG. 2 is the dip pan 4 which is placed under the electric burner 1 to support the electric burner 1, the dip pan 4 is normally made of steel which is highly heat conductive; FIG. 3 is the assembly of the cooking system 10 on the top of a typical residential electric range which includes the cooking pot 11 (includes the lid and the pot body), cooking content 14 (food), the electric burner 1 and the dip pan 4; the 13 is the top surface of the electric range where the dip pan 4, the electric burner 1 and the cooking pot 11 are located.

Let's focus on FIG. 3. The burner 1 generates heat when the electricity passes through it; the arrows of FIG. 3 indicate the directions of heat diffusion. Due to the fact that the cooking pot 10 sits on the top of the burner 1, the bottom and the sides of the burner 1 is open to the air, so there is less than half of the heat (indicated by the up vertical direction arrows) enters the pot 10 and is absorbed by the food 14, it is this portion of the heat to cook the food; more than half of the heat moves downward and sides, which is totally wasted, such wasted heat causes the range surface near the burner to be very hot.

In addition to the severe heat lose from the burner bottom and sides, there is substantial heat lose (indicated by the side arrows and top arrows) from cooking pot 10 to the environment. In FIG. 3, the burner temperature can be high up to 600° C. to 700° C., with such temperature, it is not practical to place a thermal insulation material around the side of the cooking pot to reduce the heat lose from side of the pot; furthermore, any air movement around the cooking system 10 will accelerate the heat lose (wind effect); therefore, the temperature increase of the cooking content is substantially slow due to such heavy heat lose. In general, the energy efficiency of the cooking in such assembly is about 35% or less.

Another popular type of electric range is the smooth ceramic glass cooktop range, the electric burner is under the top ceramic glass, the energy efficiency of this type is very low also.

The world population of the people is fast increasing, the consumption of the natural energy resources has been steadily increasing, which has dramatically impact to the environment and is the major contribution to the global warming effect. The limited energy resources are depleting. So it is strongly desirable to invent a cooking system with better energy efficiency with affordable cost. This not only reduces the family's electric bill, but also reduces the carbon dioxide emission, therefore, reduce the global warming effect.

It is an object of the present invention to introduce an electric cooking system with much higher energy efficiency and much less consumption of electricity and reduce living cost of normal families.

It is another object of the present invention to introduce an electric cooking system with much higher energy efficiency which can be installed on the common residential electric ranges, therefore substantially reduces the cost of such improvement.

### SUMMARY OF THE INVENTION

The present invention includes a new designed electric burner with vertical heating structure, a cooking pot with an open inward slot at the bottom in which the vertical heating structure of the burner is inserted, a ceramic or ceramic-glass plate on which the electric burner is sited, a thermal insulation unit placed around the side of the cooking pot to reducing the heat lose from the side of the pot during the cooking. In this invention, almost all heat generated by the burner is absorbed by the food and the heat lose is substantially lower than the current conventional electric cooking system.

### BRIEF DESCRIPTION OF THE DRAWINGS

FIG. 4 is the perspective view of the new designed electric burner with vertical heating structure and two terminal mounting legs.

FIG. 5 is the top view of the electric burner.

FIG. 6 is the perspective view of the mounting leg secure element.

FIG. 7 is the perspective view of the electric burner support element.

FIG. 8 is the perspective view of the assembly of the electric burner.

FIG. 9 is the ceramic or ceramic-glass plate on which the electric burner is placed.

FIG. 10 is the cross section view of the ceramic plate.

FIG. 11 is the perspective view of the assembly of the electric burner and the ceramic plate.

FIG. 12 is the cross section view of the metal cooking pot with an inward rectangle open slot at the bottom.

FIG. 13 is the cross section view of the cooking pot which is 90 degree respective to the FIG. 11.

FIG. 14 is the perspective view of the cooking pot with inward open slot (shown in dash lines) at the bottom.

FIG. 15 is the perspective view of the thermal insulation sleeve which will be placed around the cooking pot to reduce the heat lose from the cooking pot.

FIG. 16 is the cross section view of assembly of the electric burner inserted into the open slot of the cooking pot.

FIG. 17 is the cross section view of the assembly of the cooking system by the present invention.

FIG. 18 is the perspective view of the electric burner designed for the smooth ceramic glass cooktop range.

FIG. 19 is the cross section view of the ceramic glass cooktop where the burner is mounted.

FIG. 20 is the cross section view the electric burner of FIG. 19 mounted on the smooth ceramic top range.

FIG. 21 is the perspective view of the coil cooktop range installed with two present electric burners of FIG. 4.

FIG. 22 is the perspective view of the smooth ceramic glass cooktop range installed with two present electric burners of FIG. 18.

### DESCRIPTION OF THE PREFERRED EMBODIMENTS

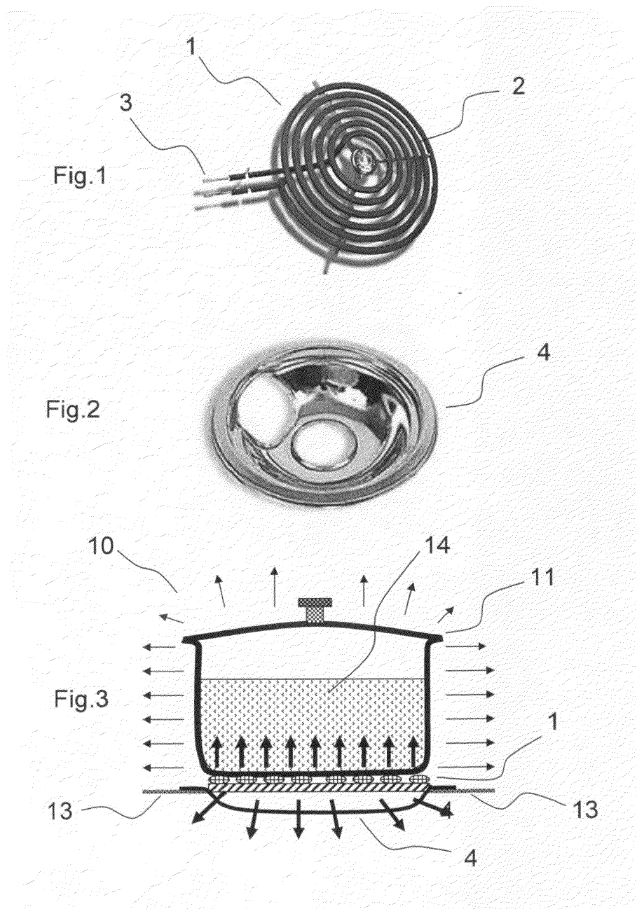

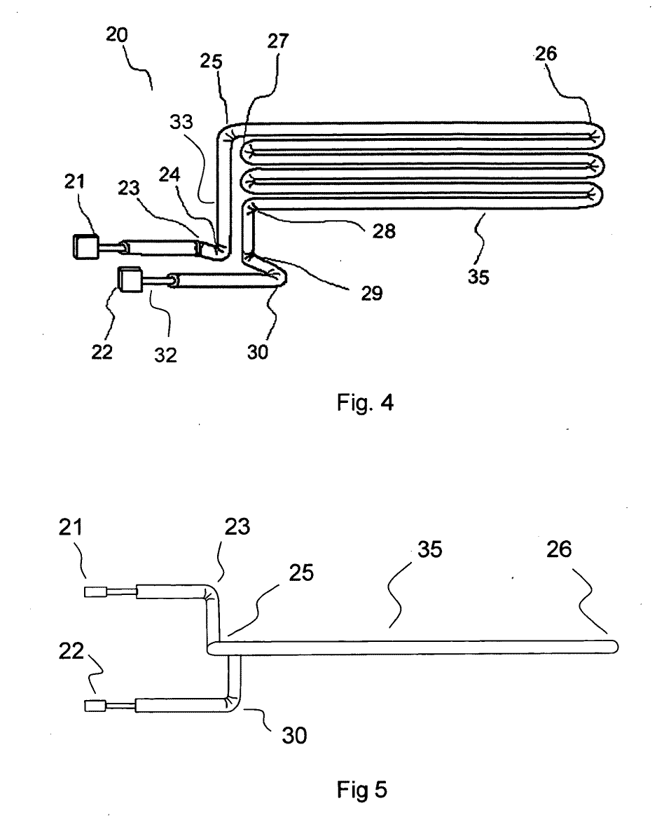

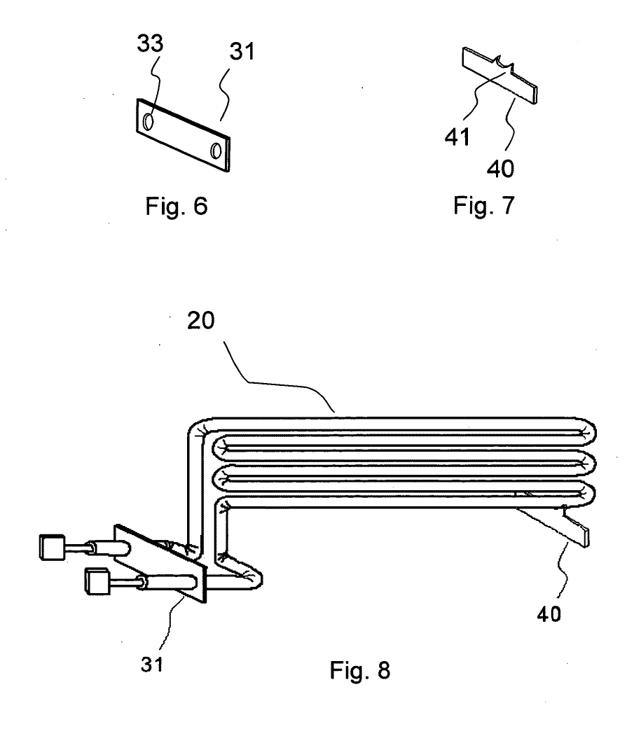

Refer to FIG. 4 to FIG. 17. In the FIG. 4, the electric burner 20 is made of tubular heating element, has two terminal mounting legs 21 and 22 which are the similar to the two terminal mounting legs 3 of conventional electric burner 1; at the position 23 of leg 21, the tubular element is bent 90 degree horizontally toward the middle; at the middle position 24, the tubular heating element is bent up vertically; at the position 25, the tubular heating element is bent horizontally along the central line; at the position 26, the tubular heating element is bent down vertically, then bent to horizontally back to the position 27, continue such construction (depending on the size of the heating element and the desired power of the burner) until the vertical heating structure 35 is finished at the position 28; at position 28, the tubular heating element is bent down vertically, at the position 29, the tubular heating element is bent horizontally outward and perpendicular to the vertical heating structure 35; at the position 30, the tubular heating element is bent horizontally 90 degree to make the terminal mounting leg 22. The position and distance of the two legs 21 and 22 are secured by the metal piece 31 shown in FIG. 6 and FIG. 8, which is similar to the conventional tubular burner 1. 32 is the terminal pin which is extended to the position 28, the terminal pin of the leg 21 is also extended to position 33 while is at the same level of position 28, the heating resistor is inside of the metal sheath of the tubular heating element and starts at position 28 and is extended through the vertical structure 35 and ends at the position 33 of the vertical structure, so only the vertical structure 35 of the burner 20 generates the heat. FIG. 5 is the top view of the said electric burner 20. FIG. 6 is the mounting leg secure element with two holes which are to secure the distance of the two legs and their positions. FIG. 7 shows the metal support 40 for the electric burner 20, there are two metal tips 41 on the top of the support to be cramped onto the burner 20 shown on FIG. 8. FIG. 8 shows the assembly of the electric burner 20, the mounting leg secure element 31 and the metal support 40.

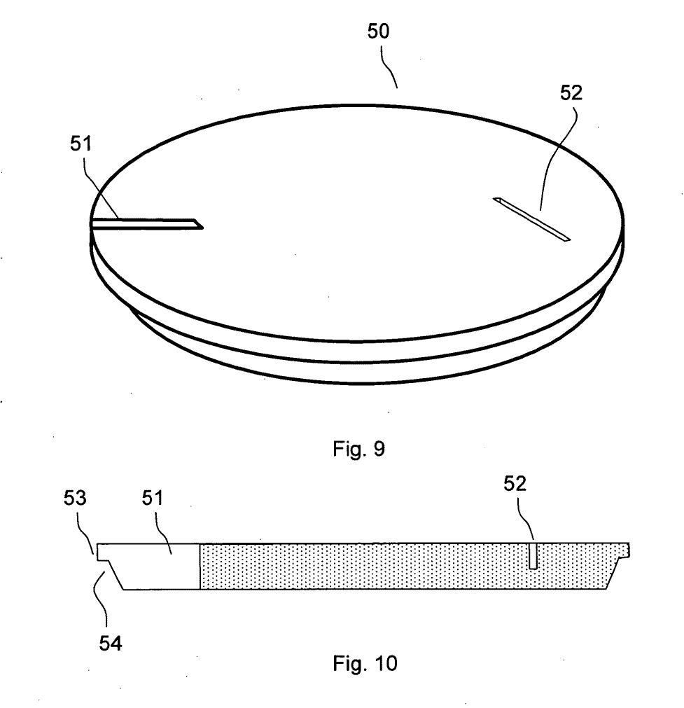

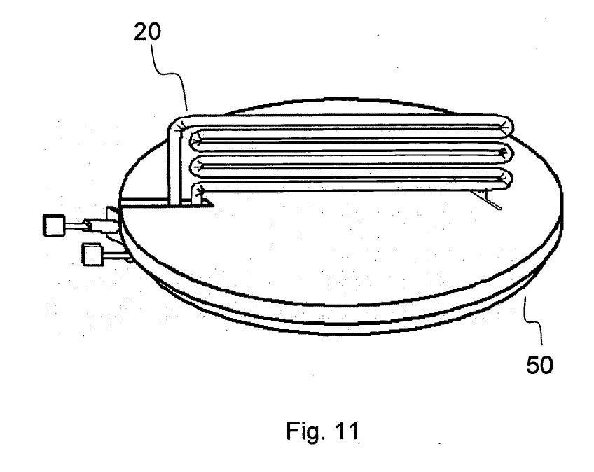

FIG. 9 shows the base plate 50 which is made of ceramic or ceramic glass; the FIG. 10 is the cross section view of the base plate 50. The base plate is round, there is an open slot 51 along the central line, the width of the open slot 51 should match the diameter of the tubular heating element of the burner 20; the second slot 52 is located at other side of the plate and perpendicular to the open slot 51, the size of the slot 22 should match length and the width of the metal support element 40, i.e., the metal support element 40 is inserted into the slot 52. The base plate 50 has a top portion 53 with a larger diameter than the lower portion 54, the diameter of the lower portion 54 of the base plate 50 should match the opening on the top of the electric range where the dip pan is normally installed, so it can be easily installed into the opening. FIG. 11 shows the configuration after the said electric burner 20 is installed onto the base plate 50.

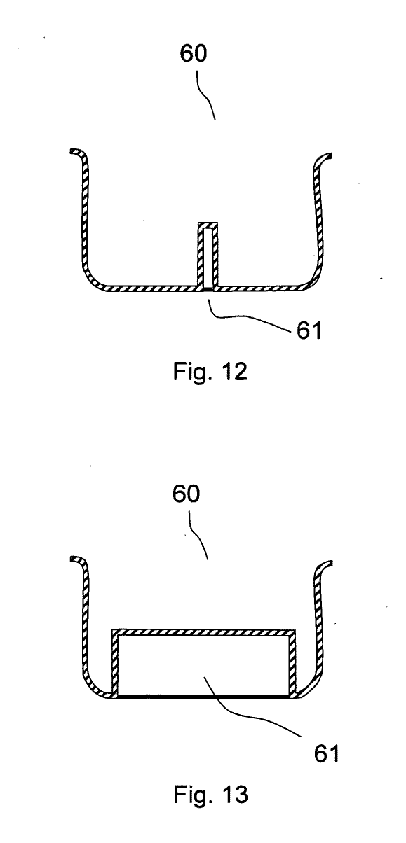

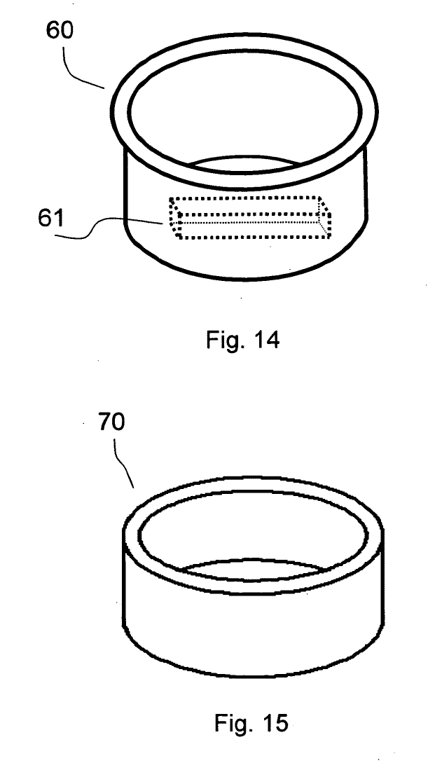

FIG. 12 is the cross section view of the cooking pot 60 (the lid is not shown), the cooking pot 60 has an inward open slot 61 at the bottom, the open slot 61 has a rectangular shape, the size of the open slot 61 should match the size of the vertical heating structure 35 of the electric burner 20. FIG. 13 is the cross section view of the cooking pot which is 90 degree respective to the FIG. 12. FIG. 14 shows the location of the open slot 61 (in dash line) inside the cooking pot 60.

FIG. 15 is the cylinder-type thermal insulation sleeve 70 which can be made of non flammable and thermal insulation fibers or other materials. This insulation sleeve is placed around the side of cooking pot 60 to prevent the heat lose from the cooking pot 60. The size of the insulation sleeve 70 should match the size of the cooking pot 60.

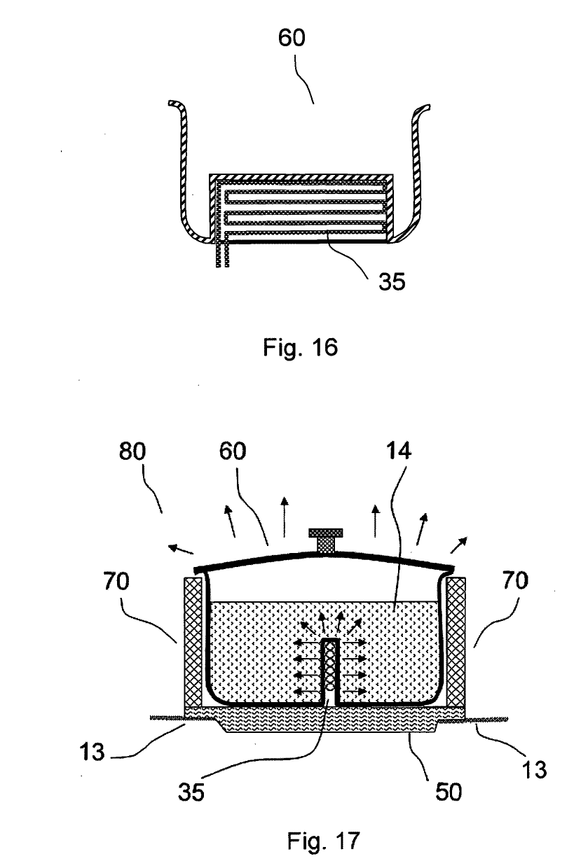

FIG. 16 is the cross section view that the vertical heating structure 35 of the electric burner 20 is inserted into the open slot 61 of the cooking pot 60.

FIG. 17 is the cross section view of the assembly of the present cooking system 80. One can see that the vertical heating structure 35 is inserted into the middle open slot 61, therefore, almost 100% of the heat generated by the vertical heating structure 35 enters the cooking pot 60 and absorbed by the cooking content 14, this is significantly improvement of the energy efficiency compared to the conventional coil type burners; furthermore, the ceramic or ceramic-glass base plate 50 is a very good thermal insulator which efficiently prevents heat lose from the bottom of the cooking pot 60. If the thermal insulation sleeve 70 is used, the heat lose is even further reduced. Therefore, overall, this cooking system improves the energy efficiency up to 3 to 4 time. There is still some heat lose from the top lid of the cooking pot 60, such lose is the same as the conventional cooking system 10 shown in FIG. 3. Another advantage of the present cooking system 80 is that if the thermal insulation sleeve is used, the heat lose due to air movement around the cooking system 80 (wind effect) is much less than the conventional cooking system 10. Overall, the heat accumulation inside the cooking pot 60 is much faster than the conventional cooking system 10; the temperature of the cooking content 14 in FIG. 16 rises much faster than that in FIG. 3. Theoretically, the energy efficiency of the present cooking system 80 can be up to more than three times of the conventional cooking system 10 based the assumption that the same amount of heat is generated by the present electric burner 20 and the conventional electric burner 1; in other word, a 500 watts present electric burner 20 is equivalent to a 1500 watts conventional electric burner 1. Therefore, people can save about ⅔ of the electricity used for cooking, such saving will substantially reduce the electric bill; this, in turn, reduces the electricity production of power plants which use coal, natural gas, oil and nuclear material to produce the electricity, therefore, reduce the consumption of the natural resources and global warming effect.

The cost of the present cooking system 80 should be comparable to the conventional cooking system 10, because much less tubular heating material is needed to make electric burner 20 than the conventional electric burner 1, it is also unnecessary to use the dip pan 4, so those savings should be able to roughly compensate the cost of insulation sleeve 70 and the ceramic base plate 50.

Due to the special configuration of the present burner 20, the present cooking system 80 is more suitable for cooking food with sufficient quantity and pretty of liquid (such as water or oil), actually, more than half of families' daily cooking match those conditions.

The common electric range has two smaller burners and two larger burners; it will be the best combination to replace two conventional burners with the present burners (one smaller and one larger), so people will have choice to select which burner to use based on what to cook.

The present burner 20 can be applied also to the smooth ceramic glass cooktop ranges without any technical difficulty.

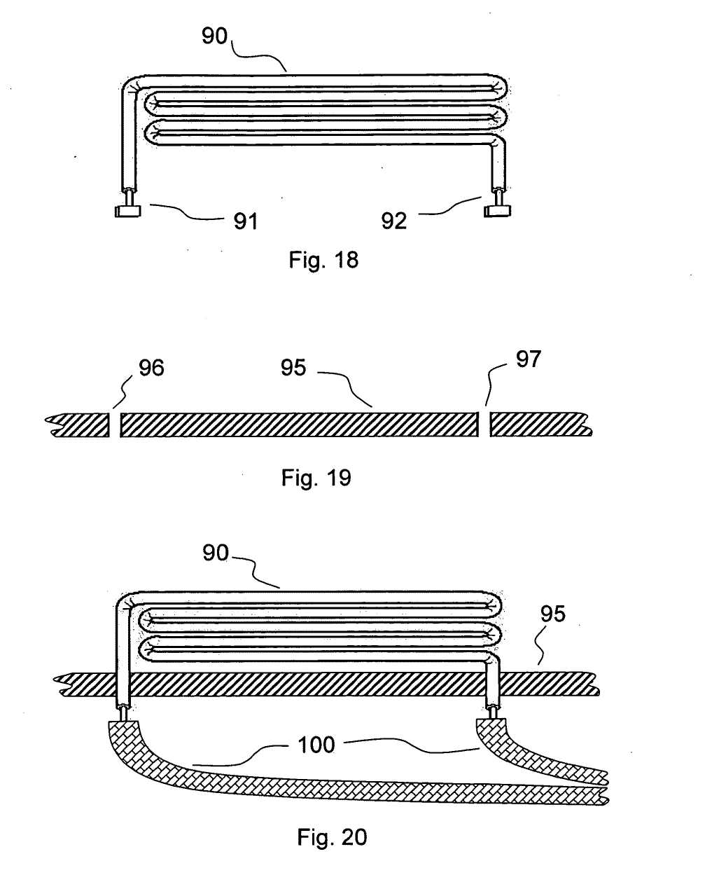

FIG. 18 is the electric burner 90 designed for the smooth ceramic glass cooktop range. In this design, the two mounting legs 91 and 92 are vertical.

FIG. 19 is the cross section view of the smooth ceramic glass cooktop 95, there are two holes 96 and 97 in the ceramic glass, the electric burner 90 can installed to the ceramic glass cooktop.

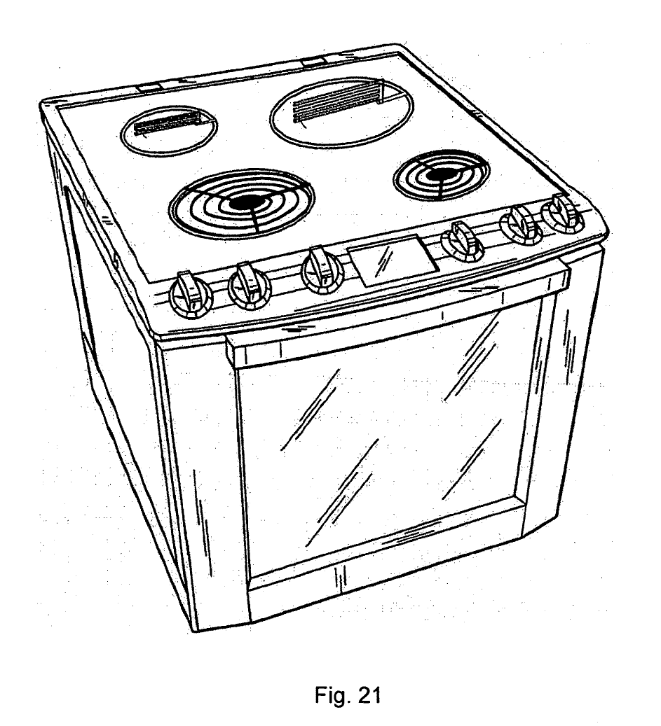

FIG. 20 is the assembly of electric burner 90 installed to the ceramic glass cooktop 95, and connected to power cables 100.

FIG. 21 is the perspective view of the electric burner 20 installed on the flat coil top electric range.

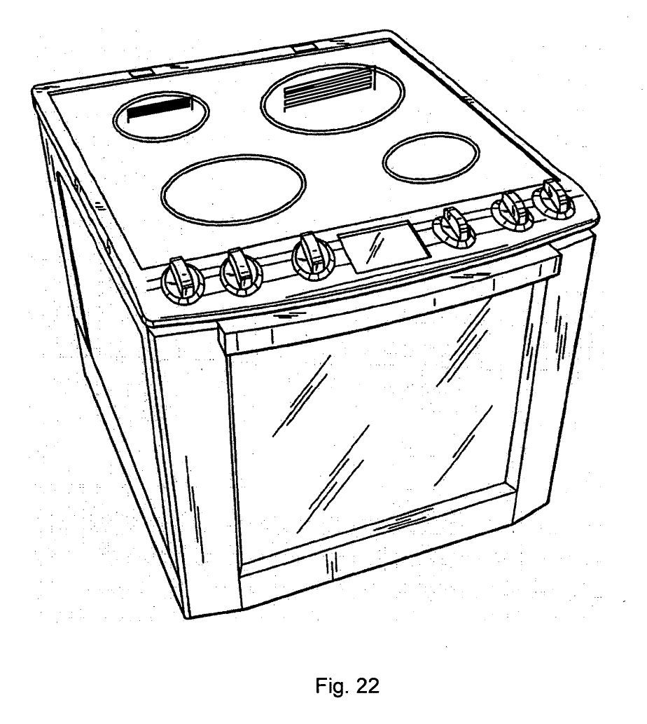

FIG. 22 is the perspective view of the electric burner 90 installed on the smooth ceramic glass cooktop range.

It should be understood that modifications of this invention will occur to those skilled in this art, therefore this invention is not limited to the particular embodiments disclosed but that it is intended to cover all modifications which are within the true spirit and the scope of this invention as claimed.

What I claim as my invention is:

1. An electric cooking system contains an electric burner, a cooking pot, a ceramic base plate and a thermal insulation sleeve.

2. The electric cooking system of claimed 1 can be mounted on the top of electric ranges and other devices for cooking and heating purposes.

3. The electric burner of claim 1 has a vertical heating structure and two terminal mounting legs

4. The cooking pot of claim 1 has an inward open slot at the bottom; the vertical heating structure of the electric burner of the claim 1 can be inserted into the open slot.

5. The ceramic base plate of claim 1 is placed at the opening of the surface of the electric range to support the electric burner of claim 1 and the cooking pot of claim 1.

6. A thermal insulation sleeve of claim 1 is placed around the out side of the cooking pot of claim 1 to prevent the heat lose.
